(19) United States
(12) Patent Application Publication
(10) Pub. No.: US 2001/0032905 A1
(43) Pub. Date: Oct. 25, 2001

(54) Method and apparatus for converting electrostatic potential energy

(76) Inventor: Peter Grandics, Carlsbad, CA (US)

Correspondence Address: OPPENHEIMER WOLFF & DONNELLY LLP, Suite 3800, 2029 Century Park East, Los Angeles, CA, 90067-3024, US

(21) Appl. No.: 09/732,110

(22) Filed: Dec. 7, 2000

Related U.S. Application Data
(60) Provisional application No. 60/169,378, filed on Dec. 7, 1999.

(51) Int. Cl. B64C 15/00; B64C 27/82

(52) U.S. Cl. 244/51

(57) ABSTRACT

A new method is described to produce directional currents in the space lattice, the fundamental fabric of the universe. The currents may be unidirectional or vortexual in nature and are suitable for propulsion or the generation of electric power. For propulsion, the unidirectional currents are induced by charging capacitors possessing suitable geometries. This will allow the manufacture of vehicles capable of levitation and flight. The vortexual space lattice currents are produced in a suitable pyramid when electrostatic and magnetic fields interact transversally. The vortex causes charge separation and current in the coil wrapped around the pyramid.

### CROSS-REFERENCES

This application claims priority from Provisional Application Ser. No. 60/169,378, by Peter Grandics, filed Dec. 7, 1999, also entitled “Method and Apparatus for Converting Electrostatic Potential Energy,” the contents of which are hereby incorporated by this reference.

### BACKGROUND OF THE INVENTION

This invention is directed to methods and apparatus for conversion of electrostatic energy. Specifically, this invention describes methods to cause directional movements in the space lattice.

To fully comprehend the theoretical basis for these methods, first the genesis of the elemental particles electron and positron needs to be discussed based on geometric or space relationships, and their interactions at the sub-elemental particle level must be clarified. The advantage of such an approach is that it can be visualized, and not just expressed mathematically. by definition, the word “structure” implies a geometric relationship, and such relationship must be of great importance in atomic structures even though they are hidden from direct view.

The study of geometric relationships of macroscopic structures of matter may provide important insights into the properties of matter at the microscale. Astrophysics suggests the universe probably started with an energy burst from one point. This big bang theory is supported by visual and electronic evidence that the galaxies are expanding away from a single center.

In stellar formation, gravitational pull and velocity generate a rotary vortex. Even in the relative absence of such factors, all objects spiral at some given rate peculiar to their special influences. A spiral is created when an object moves forward while rotating. Earth's movement in space is an example of this process. The Earth orbits the sun, while the sun pulls it along towards the direction of Vega in the constellation Hercules. the combined circular and forward motion creates a spiral. Our sun has the same motion in relation to the galaxy center. Our galaxy, the Milky Way, also spirals away from the Big Bang center.

Water going down a drain demonstrates some of the special influences affecting spiral formation. The spiral, caused by Coriolis forces, changes dynamically under the effects of gravitational pull, drain diameter, obstructions, temperature, pressure, volume, viscosity, and stirring. The spiral changes shape and acceleration but maintains the universal shape of a spiral. The water flow is responsive to all possible factors, and so is the spiral.

Remarkably, the spiral vortex has a “memory” of itself. When a vortex is distorted to become elliptical, it spontaneously returns to its original circular form. The vortex is a self-sustaining type of motion; its resiliency is comparable to that of atomic bodies.

Spirals condense energy and sine waves transmit it along a frictional line of force between them (FIG. 1). Spirals and waves could be considered illusions of each other. Two opposed spirals form a wave, or a wave produces two spirals. A sine is the producer of waves of spiral forces. Any fluid capable of supporting wave motion can also support vortex motion.

The spiral is the prominent form of organization of matter. The large proportion of spiral galaxies among celestial bodies visibly demonstrates this. On the microscale, even the building block of life, the DNA uses this structure and spirals are likely to be dominant at the level of the atom and below. This is the subject of the present theory. I propose that all atoms, all stellar formations use the mutable spiral to adapt to their spiral environment.

Another proposition is that all mediums of matter can be considered a type of crystal. Crystallinity is readily recognizable in the mineral world, but it is also a more general state of matter. Besides solid crystals, liquid crystals also exist. by definition, a crystal is a regularly repeating atomic arrangement, such as a chemical element, a compound or an isomorphous mixture. Therefore, the term crystal applies to material expressions where crystallinity is not so obvious, e.g., gases, complex biologics and various life forms, including viruses, bacteria and higher organisms. Air and water could be considered loose crystals subject to fast molecular drift. At low temperatures where molecular drift is reduced, gases form solid or liquid crystals. Soil and stone and metal are opaque cryptocrystals with slower rates of molecular drift. On the macroscale, the Earth could be seen as faceted crystal with its mountain ridges are the ridges of a geodesic sphere. Biopolymers such as DNA, proteins or polysaccharides fit well the definition of a crystal and are commonly made into crystals. All life can be seen as a crystal. From fish to humans, we are liquid crystals on a skeletal lattice.

Crystals are the shape of discrete units of matter and notably the channelized direction of energy, that is, the direction energy that flows unforced. Crystals form the basis for corpuscle-wave conversion. Crystals create resonance and conduct the flow of energy between states. Crystals can also be considered lenses. By definition, a lens is a device capable of refracting, or bending light. Light is an energy flow, so on a more general term, a lens can be defined as any object capable of changing the direction of energy flow. By this broader definition, even an electric wire is a lens as it is capable of changing the direction of flow of electrical energy. lenses communicate energy as part of the principle that all matter vibrate, all matter transmit, and all matter receives energy. The universe changes energy states with lenses. Following this line of reasoning, the universe could be viewed as a resonant crystal lens.

This observation is important because the universe is considered to be largely empty, the largest component of which is the so-called vacuum space. Since Nature seems to use the same geometrical organizing principles from macro to micro, I suggest that the vacuum space must also be “crystalline”. Since the term crystalline is associated with material of which the vacuum space is substantially devoid, I will use an extended meaning of “structured” when discussing crystallinity of vacuum space.

The theory of “crystalline” vacuum space was introduced by Simhony (Simhony, M. (1990) The Electron-Positron Lattice Space, Cause of Relativity and Quantum Effects, Physics Section 5, The Hebrew University, Jerusalem., and Simhony, M. (1994) Invitation to the Natural Physics of Matter, Space, and Radiation, World Scientific Publishing Co., London, UK.). Simhony reasoned that three-dimensional physical phenomena must have three-dimensional physical causes and explanations.

He demonstrated that physical reality can be described by the laws of classical physics supplemented by the presence of a space lattice. This led to the development of the theory of an electron-positron lattice space (epola for short). In the epola, bound electron-positron pairs reside at the lattice sites of a face-centered cubical “crystal” structure similar to that of NaCl crystals (Kennon, N. F. (1978) Patterns in Crystals, John Wiley & Sons, New York.).

The epola theory allowed a physical explanation of all yet unexplained postulates of quantum mechanics and relativity including the particle-wave duality, the quantized nature of electron orbits in the atom, the electromagnetic radiation, the photon, and gravitational interactions as well as the relationship of electrostatic, magnetic and gravitational interactions. He demonstrated gravity to be a derivative of electromagnetism.

There is a large body of evidence suggesting that the vacuum space is not empty at all. Experiments verify that the vacuum space contains an enormous residual background energy (some examples are: Boyer, T. H. (1985) The classical vacuum (zero-point energy) Scientific American 70-78, Haisch, B., Rueda, A. and Puthoff, H. E. (1994) Beyond E=mc², The Sciences, 34, No. 6, 26-31, and B.

Haisch and A. Rueda, (1999).On the relation between zero-point-field-induced inertial mass and the Einstein-de Broglie formula, Physics Letters A, in press), called zero-point energy (ZPE). The ZPE manifests as a pervasive and vast electromagnetic field called the zero-point field (ZPF). a dynamic field, ZPF is a virtual plasma, with particles arising and disappearing of a background energy field serving as a baseline, or zero point, for all physical processes. The ZPE remains even at absolute zero. Simhony has described zero-point energy fluctuations as analogous to brownian motion of epola particles around their lattice sites. A potential alternative term for the lattice space is zero-point-field (ZPF) described in 1994 by Haisch, Rueda and Puthoff (Haisch, B., Rueda, A. and Puthoff, H. E. (1994) Beyond E=mc2, The Sciences, 34, No. 6, 26-31). This area remains an active field of research.

Simhony also suggested that all particles of matter are directly formed from the lattice space, the mechanism of which remains undetermined. The present theory intends to answer this question in terms of lattice space.

I propose that the vacuum space has a lattice structure similar to that introduced by Simhony. this structure is a face-centered cube having 27 lattice sites (FIG. 2). on the lattice sites reside the elemental “particles” forming all particles of matter. These are “particles of energy” rather than particles of matter.

I propose that the “particle of energy” of the space lattice, called here the subtle electron, is a spiral energy vortex tied into itself in the form of a circumvolution cissoid. The circumvolution cissoid is a spiral turn around an axis converging into an apex, in a self-imploding, self-sustaining vortex motion (FIG. 3). The vortex pulsates and its vibration is a function of (2_Ø)x, where Ø is the Fibonacci series number and x=0,1,2,3, the number of turns the circumvolution cissoid makes. Once started up, such a vortex would run practically indefinitely inside the space lattice.

The internal friction of such a space lattice must be so low that it would only be noticeable as a red shift in the spectra of distant galaxies. The space lattice, like its constituent energy vortices, must also be a resilient structure with only limited compressibility. At the same time, it must have fluidity since it is capable of transmitting waves with transverse displacement. In the absence of atomic oscillators, the space lattice would be incapable of dissipating energy in the form of heat.

Vortices maintain their circular forms as well as their proportions and dimensions. The adjacent vortices have a coordinating effect that establishes axial alignment and rolling contact between vortices within the space lattice. In that sense, there is a great deal of similarity between crystals of material bodies and the structure of the space lattice. I postulate that the space lattice is an incompressible, frictionless fluid made out of cubes of units cells of subtle electron vortices.

We can consider the space lattice equivalent to motion. A space lattice in motion necessarily has inertia. Although inertia is generally attributed to moving material bodies, it is actually a property of motion. Inertia is just the continuity of motion. In the case of vortex motion the inertia is localized. Localized inertia can also be called momentum. To account for the elemental particles of matter, we need a space lattice that is capable of moving.

Anderson discovered in 1932, that when 1.02 MeV photon energy is absorbed into the vacuum space, an electron-positron pair can appear. this observation is explained here as a glimpse into the formation of elemental particles of matter. To become matter, energy must become more angular. This hypothesis is derived from the observation that all material expression is a type of crystal, and is the compound and derivative of a fundamental triangular form which all the seven crystal systems can be derived (Kennon, N. F. (1978) Patterns in Crystals, John Wiley & Sons, New York.). The mechanics of this expression at the level of the space lattice are explained as follows: As the energy of electromagnetic radiation propagates through the space lattice, it polarizes the subtle electron energy vortices (for analogy see FIG. 1). Subsequently, the “energy particles” of the space lattice, the subtle electrons, undergo a phase transition similar to the condensation of gases. This happens at the resonant frequency of the 1.02 MeV gamma radiation.

The 27 subtle electrons of the unit cell of space lattice rearrange into a pyramidal segment of the cube (FIG. 5) on six levels each forming circles of vortices. An open-flat presentation of the rearrangement is shown in FIG. 4. This structure is the postulated smallest unit of matter. note that the cube is composed of six interlocking pyramids so the cube and the pyramid are resonant structures. Inside the pyramid, the subtle electron rings form a vortex capable of circulating the fluid space lattice. The pumping action is driven by the self-sustaining, pulsating vortex motion of its constituent subtle electrons (FIG. 3). The overall shape is a cone fitting inside the pyramid. The formation of matter follows the geometry of the space lattice (FIG. 5) and thus we may conclude that the space lattice provides the blueprint for matter.

An electron is produced when two such cones are joined in a tip-to-tip conformation (FIG. 6). The positron is made out of two vortices (cones) facing base-to-base. The energy vortices which make up the electrons have a resilient vibratory structure which should be capable of vibrating at various frequencies and modes. This would allow us to account for the series of spectral lines, a signature of absorbing and emitting energy at various frequencies.

These complex vortex particles have a pumping effect and circulate the fluid space lattice. For the electron, the space lattice is drawn in polarly and expelled equatorially. For the positron, the space lattice is drawn in equatorially and expelled polarly (FIG. 7). The direction of circulation of fluid space lattice determines the positive or negative polarities. When in close proximity, a specific flow coupling occurs between the electron and positron (FIG. 7). It is quite probable that a similar flow coupling exists between a proton and an electron inside the atom, although such coupling is stable in the case of the proton. This is likely a result of the different vibratory structure of the vortex proton.

The instability of the electron-positron pair is also derived from this model. The perfectly fitting, counter-rotating cones of energy extinguish each other with the release of a combined energy of 1.02 Mev. This results in the reconstitution of the respective unit cells of the space lattice along with the release of the phase transition energy.

The size of the subtle electron is estimated based on the “nuclear radius” of 0.1 fm for the electron, to be approximately 0.005 fm. The lattice constant for the unit cell of space lattice is approximately half of the “nuclear radius” of the electron, i.e,.0.05 fm. This indicates that the space lattice is quite dense compared to atomic bodies.

The model explains the attraction of free electric charges as follows (FIG. 8): Opposite charges move towards each other. This movement is due to the equatorial circulation of fluid space lattice from the negative charge to the positive charge and the polar circulation of space lattice from the positive to the negative charge. The attraction of the vortices pull the two partners together. The electrostatic field between separated charges is defined as the flow of the space lattice from the protons to the electrons and the outside return flow of space lattice from the electrons to the protons (see FIG. 8). This explanation will eventually lead to a hydromechanical theory of electricity.

Interestingly, there is a net unidirectional flow of fluid space lattice in the axial direction of the free electric charges (FIG. 8) flowing in at the negative pole and flowing out at the positive pole. if the charges have a steady parallel orientation, e.g., as in an electric condenser, then a pressure differential must arise in the space lattice around the opposite poles of the condenser. To fully appreciate the significance of this conclusion, we must first examine how material bodies accelerate through the space lattice.

Accelerating objects encounter resistance facing an increased pressure of the space lattice at the front end and a reduced pressure at the rear end of the object. This situation is common to all propulsion methods which apply mechanical force on the physical object. Therefore, it is logical to suggest that a pressure differential of space lattice at the opposite sides of material bodies is always accompanied by a change in the rest or motion of such bodies. To obtain a propulsion force, instead of exerting force on the physical object we should transfer the space lattice that controls the behavior of the object from the rear end of the object to its front end.

Therefore, a sufficiently charged object in which the charges have a steady parallel orientation should behave as an accelerating object, i.e., it should move toward the direction of its positive pole. In fact, this happens due to its own generated space lattice pressure differential Now that the fundamentals are developed, the effect may provide the basis for a new propulsion and gravity cancellation method, and may give us insights into the mechanism of gravitation. A craft utilizing such propulsion method could exhibit inertialess acceleration as it would meet no resistance from the surrounding space lattice.

The theory also allows us to develop strategies for tapping into the energy of the space surrounding us. Separated charges in an electric condenser cause a directional flow of the fluid space lattice. Conversely, if we could induce a directional flow of the space lattice, it would cause a separation of charges in material objects. To explain how such an effect could be produced, first the physical basis of magnetism must be explained.

I have described the physical basis for the electrostatic field as a flow of a space lattice current from the positive charges to the negative charges and back on the outside to the positive charges. I shall now explain how these space lattice currents flow in an electric wire. The space lattice flow which connects the electrons to the protons of the atoms in the wire becomes extended in the length of the wire. This is the same direction as the direction of movement of electrons which, in the current, flow in the outer shell of the wire. The external return flow of the space lattice will be in the opposite direction in the space around the wire. This flow constitutes the magnetic field. In a solenoid, the surrounding space lattice flows in the opposite direction relative to the path of the electrons. The magnetic effect will appear as either N or S magnetic poles. The magnetic poles are mirror images of each other. This suggests that a single isolated magnetic pole cannot exist.

In the electrostatic field, the outside space lattice currents flow between electrically charged particles. The magnetic field, on the other hand exhibits a closed circuit flow of the space lattice along the path of a solenoid or a circuit. Electric and magnetic forces are produced by movement of the space lattice in spirals or whirls.

An electric charge and a magnetic pole do interact even though they do not apply any force to each other. A magnetic pole will bring about a directional orientation of the electrons in a charged object, while an electric charge will cause the electric polarization of the adjacent surface of a magnetic pole.

The final question remains is the superimposition of electrostatic and magnetic fields on each other. The practical significance of the interaction of axially oriented electrostatic and magnetic fields is likely to be small compared to their interaction at an angle. A transversal superimposition of a magnetic field on an electrostatic field will cause the distortion of both fields. The axial flow of the space lattice between the electric poles, which is the physical basis for the electrostatic field, will be distorted, but its circulation will continue. Similarly, the rotating space lattice, which is the basis for the magnetic field, will also be distorted, flowing in irregular circuits.

To study the transverse superimposition of electrostatic and magnetic fields, a shaped electrostatic field must be created (FIG. 9). When a magnetic field interacts with the shaped flow of the space lattice, it could result in the formation of a space lattice vortex at the points where the two flows intersect. This is based on previous hypothesis that the space lattice is an incompressible fluid, wherein the intersecting currents cannot penetrate but distort each other's flow patterns.

To expand this shaped electrostatic field into three dimensions, a pyramid is required. I have already discussed the importance of the pyramidal geometry in the formation of matter. The pyramidal geometry may also be important for producing a space lattice perturbation, which is the equivalent of a magnetic field when it follows a rotational symmetry (e.g. a vortex).

If with transversally superimposed electrostatic and magnetic fields a pyramid did indeed produce a vortex in the space lattice, then the rotational flow of the space lattice should cause the separation of charges and an electric current in material bodies, as predicted by this theory. This means that under appropriate conditions, a pyramid could become a power generator.

For power generation in a pyramid, the source of the electrostatic and magnetic fields could potentially be the Earth. The earth has a high voltage electric field such that the earth's surface is negatively charged while the atmosphere is positively charged (Feynman, R. P. (1964) Lectures on Physics, v.2, 9-2, Addison Wesley, Inc., Palo Alto, Calif.). The voltage field is believed to be maintained by the Sun's radiation energy and/or cosmic ray energy and extends from the ionosphere to the surface creating a potential difference of about 400,000 V. The Earth's electrostatic field never seems to get depleted despite all the storm activities and discharging of energy. The voltage gradient is estimated to be 200 V/m around the surface of the earth. The total energy reaching earth at any moment is about 700 MW (400,000 V multiplied by a current of 1800 A). The magnetic field strength of the earth is about 0.5 Gauss and exhibits continuous pulsations with main frequencies of 8 to 16 Hz.

Therefore, the earth's electrostatic and magnetic fields could potentially be utilized to create a space lattice vortex in and around a sufficiently sized pyramid. This hypothesis has been tested experimentally. The earth's electrostatic field was modeled as described in the Examples.

Therefore, there is a need for an improved method and apparatus for the conversion of electrostatic energy as described herein.

### SUMMARY OF THE INVENTION

Pursuant to this invention new techniques are described to produce directional currents in the space lattice. The currents are induced either by separated charges, properly positioned magnetic fields or by the interaction of electrostatic and magnetic fields at an angle, specified by the side angle of a pyramid. The induced space lattice currents can be utilized to generate specific effects which may vary from propulsion, to gravity cancellation and power generation.

In particular, an aspect of the present invention is a method producing directional currents in the space lattice utilizing:

(1) separated electric charges; and

(2) the interaction of electrostatic and magnetic fields.

In one preferred embodiment of the invention, electric charges are separated in an oriented fashion. The orientation can be a parallel orientation. The orientation can be obtained in a capacitor. The capacitor can be used for the propulsion of a vehicle. The capacitor can provide lift and lateral movement control for said vehicle.

The interaction of electrostatic and magnetic fields can be set up in a pyramid.

The interaction can produce a vortex in the space lattice.

The vortex can be tapped to produce electric power, which can be obtained by wrapping a coil around the pyramid.

### BRIEF DESCRIPTION OF THE DRAWINGS

The following invention will become better understood with reference to the specification, appended claims, and accompanying drawings, where:

FIG. 1 is a diagram showing the relationship between a spiral and a wave;

FIG. 2 is a diagram demonstrating the geometry of the space lattice;

FIG. 3 is a diagram demonstrating the circumvolution cissoid;

FIG. 4 is a diagram demonstrating the smallest unit of matter;

FIG. 5 is a diagram showing the rearrangement of the unit cell;

FIG. 6 is a diagram exhibiting the structures of electron and positron;

FIG. 7 is a diagram demonstrating the flow coupling of electron and positron;

FIG. 8 is a diagram showing the attraction of electric charges;

FIG. 9 is a diagram showing the interaction of a shaped electrostatic field with a magnetic field;

FIG. 10 is a diagram displaying the arrangement of the capacitors in the craft; and

FIG. 11 is a diagram demonstrating the pyramid experimental setup.

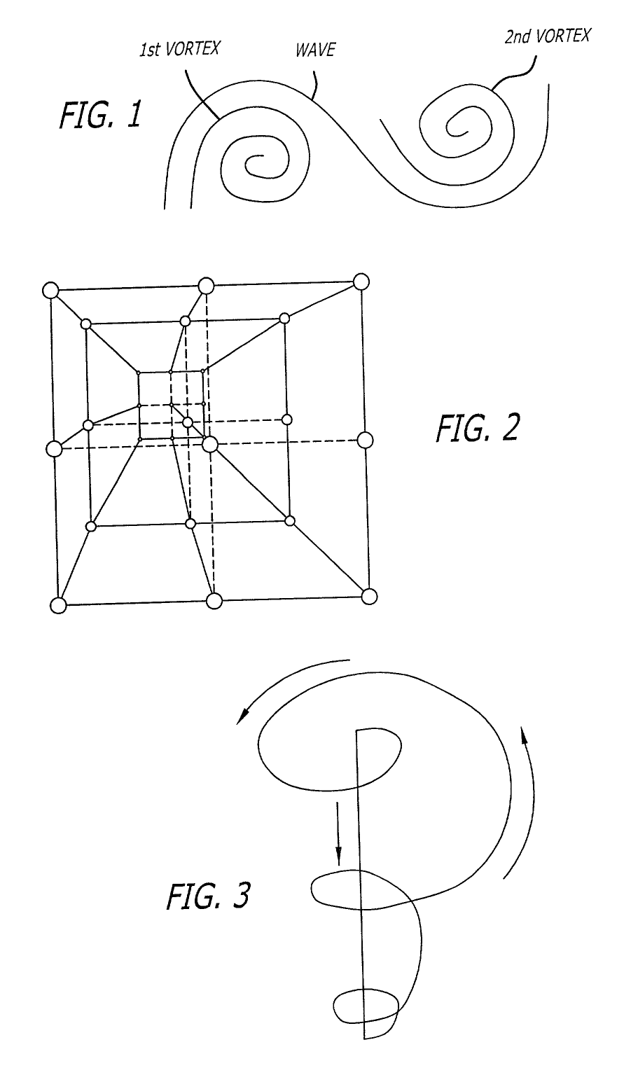

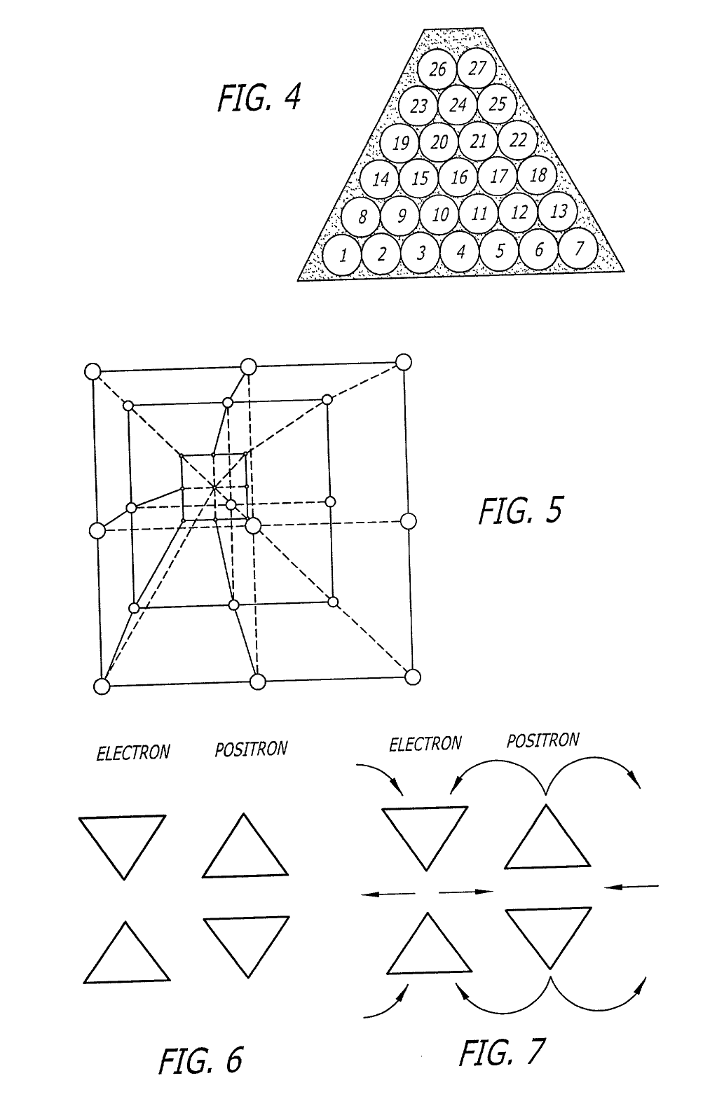

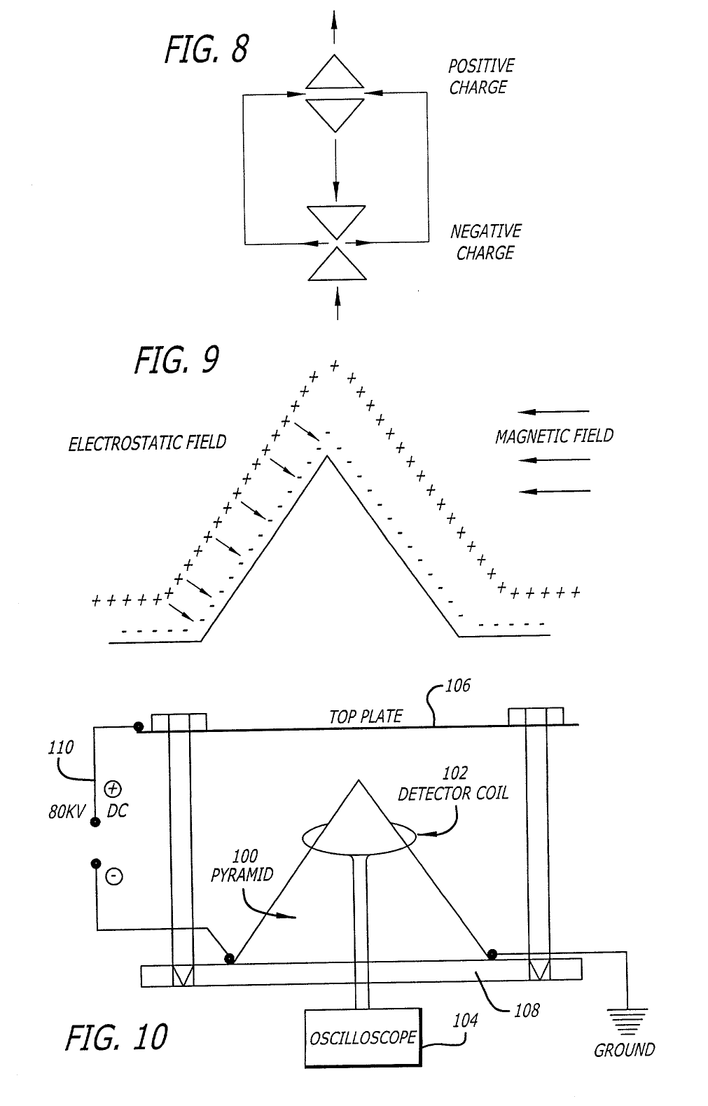

### DESCRIPTION OF THE PREFERRED EMBODIMENT

Pursuant to this invention, novel methods are described to induce directional currents in the space lattice which is postulated to be part of the boundary conditions of the Universe. These methods are useful in providing for the conversion of electrostatic energy into a useful form. The first method relates to generating an unidirectional flow of the space lattice which could be useful in cancelling gravity and generating a propulsion force. A possible configuration for keeping the charges separated and stored is in the form of a capacitor. The shape of the capacitor and the body of such device is important for optimal performance. A pyramidal or conical shape is preferred for the alignment of the capacitors (FIG. 10). Optimally, the shape of the capacitor follows the shape of the craft.

In FIG. 10, the pyramid 100 is surrounded by a detector coil 102 which is in turn connected to an oscilloscope 104. In the experimental setup shown, the field is established by a top plate 106 and a ground 108 connected to a source of DC electrical energy 110.

The conductive elements of the capacitor are layered into the pyramidal or conical segment of the hull of such craft. Optimally, there should be several layers of negatively charged conductors on the outside while a single layer of positively charged conductor in the inside of the craft. All conductive elements should be carefully insulated in order to keep the charges inside the capacitor.

In the center of the craft, a conductive, insulated pole is mounted such that the pole extends out into the exterior at the top of the craft. The tip of that pole has a metal ball mounted on which is also positively charged. When all the capacitor plates are charged, they induce an unidirectional, upward flow of the space lattice. This means that the space lattice pressure above the craft will be higher than the space lattice pressure at the bottom of the craft. This pressure differential is unstable and progresses towards an equilibrium. It will grab the craft and propels it forward in order to eliminate the pressure gradient. This requires that a sufficiently high voltage be applied. My estimation is that about 5 kV is needed to lift every gram of an object. The capacitors incorporated into the hull will give control over lift.

To obtain directional control over all three axes of movement, three capacitors need to be mounted at the bottom of the craft apart from each other. These capacitors, could take the shape of a ball and would be mounted on retractable shafts. The top half of the capacitors would be positively charged while the bottom half is negatively charged. When in flight, the capacitors are retracted and charged based on the needs of directional control. To achieve forward movement, the charges on one capacitor facing the direction of the desired path should be reduced relative to the other two capacitors. This would make the craft tilt forward and start moving in that direction. An alternative method of lateral directional control could be obtained by dividing the capacitor bank in the hull into segments which segments could be charged individually.

Upon landing, the three ball capacitors would be protracted on their shafts and serve as landing gear. On landing, they would be discharged because the earth is the greater ground. On launching, the main capacitors of the body would be activated causing a lift-off. The three capacitor landing gear would then be retracted and charged up so that they can function for lateral directional control. On-board static generators would supply the voltage required for the operation of the craft.

The most significant aspect of this type of propulsion system would be the loss of inertia during acceleration. Inertial forces pose great obstacles to improving the performance of current propulsion techniques. Since we are now in control of the space lattice surrounding the craft, it will encounter no resistance from the space lattice. The passengers of such craft would feel no forces acting upon their bodies even if the craft achieved enormous accelerations.

This overall design is suitable for the development of a wide range of transportation vehicles, from automobile-type to aircraft and spacecraft. The impact of such a technology on our economy would be enormous. We could eliminate a major factor in environmental pollution, the generation of greenhouse gases which place a great stress on our ecosystem. In the United states, 66% of the greenhouse gases are produced by transportation vehicles and just 34% by power generation. The signs of global warming and the deterioration of the ecosystem are visible from every direction.

The developing countries are bent on establishing the same economical model evolved in the developed countries, representing about 16% of the world population. Worldwide mass deployment of our current energy technologies would most likely cause an environmental catastrophe which may terminate higher life-forms on this planet.

This makes it very important that the focus of our energy sector shifts towards renewable, non-polluting sources of energy. The subject invention offers a solution in this regard. The transversal interaction of electrostatic and magnetic fields in and around a pyramid offers the potential to tap into the electromagnetic field of our planet. I have found that a pyramid becomes a power generator when the electrostatic voltage field gradient of the earth is reproduced around it. Tapping the energy field was as simple as placing a coil around the pyramid.

The optimal size production pyramid is likely going to be large. The optimal material composition may be alternative layers of metal and dielectric to maximize the total amount of charges the pyramid can hold. This is important for increasing the performance of the pyramid. A coil is then wrapped around the pyramid to tap into the generated field. The orientation of the pyramid to the magnetic North pole does not seem to be a prerequisite for operation. Such a pyramid generator will be called the pyramitron.

The following Examples illustrate the features and advantages of the subject invention. Accordingly, it is to be understood that the description in this disclosure is to facilitate comprehension of the invention and should not be construed to limit the scope thereof as persons skilled in the art can, in light of this disclosure, generate additional embodiments without exceeding the scope or departing from the spirit of the claimed invention.

### EXAMPLE 1

Demonstration of the pyramitron: For the experiments, I have randomly selected a one-foot base length foam pyramid from a pyramid vendor (The Pyramid Project, Ft. Wayne, Ind.). The outside of the pyramid was covered with aluminum foil. The pyramid was placed on a 2′×2′ insulating polyethylene platform equipped with an adjustable height 2′×2′ size aluminum top plate, 1/16″ thick (FIG. 10). The height of the aluminum plate was adjusted as needed and a gap of 1 ¼″ between the plate and the tip of the pyramid was used in the experiments.

A high voltage (HV) CRT power source producing 30 kV DC was taken from a television set. I have assumed that an actual energy producing pyramid should be relatively high in order to obtain a large voltage drop from its tip to the ground. Therefore, assuming a height of 150 m for a life-size pyramid and a voltage drop of 200 V/m near the surface of the Earth, the 30 kV voltage is in the range of the voltage-drop expected for the height of a practical size pyramid.

The positive pole was attached to the top aluminum plate. This simulated the positive charge of the atmosphere. One corner of the pyramid was attached to the negative pole of the high voltage power source, while the opposite corner of the pyramid was grounded. This setup served as a model for the electrostatic field distribution around a potential life sized pyramid.

As controls, either a 1′×1′ sheet of aluminum foil or an aluminum foil-covered box, having the main dimensions of the test pyramid (1′×1′×⅝″), was used as a negative pole. The detector coils were made by winding up a 24 gauge enamel-coated magnetic wire (20 turns, approximately 8 cm diameter). A Tektronix high-frequency oscilloscope, model no.2236 was used for signal acquisition and analysis.

The first set of experiments were control measurements with the box of the same height and base lengths as the test pyramid. The detector coil was placed on the top of the box. Measurements were taken with and without the high voltage applied. One corner of the box was attached to the HV power source (negative pole) and the opposite corner to the ground. The same arrangement was used for the flat square (1′×1′) foil. The peak-to-peak signal amplitude for the box was 8 mV and the signal frequency was 2 MHz. For the flat foil sheet, the signal amplitude was 12 mV with a frequency of 1.43 MHz. The signal form was of a decaying sine wave.

When high voltage was applied to these shapes, a signal amplitude of 14 mV was obtained for the flat sheet and a 16 mV for the box. The signal frequency was 1.54 MHz for the flat sheet and 2 MHz for the box. The wave forms were of decaying sine waves in all these experiments.

When the pyramid was tested without HV, the peak-to-peak signal amplitude was measured at 60 mV with a frequency of 2 MHz. The wave form was different from those of the control experiments; it was a modulated, decaying sine. When the high voltage was applied, the signal amplitude increased up to 180-200 mV, while the frequency remained at 2 MHz. The pyramid produced a signal intensity significantly higher than the controls. When a metal (aluminum) pyramid of the same size (wall thickness 1/16″ inch) was tested in the same high voltage field using the same detection coil, a voltage of 1-1.5 V was detected at the frequency of 2 MHz.

The experiments confirmed theoretical assumptions about the pyramidal shape's ability to cause perturbations in the space lattice when the pyramid is placed in transverse electrostatic and magnetic fields. The resulting space lattice vortex causes a separation of charges in the detection coil, producing a voltage signal greatly exceeding control levels. Control values for the flat sheet and the box in the electrostatic field were at the level of the background noise. Thus, when the electrostatic and magnetic fields intersected at 90° or 0°, no effect was observed. However, when the fields intersected at an angle defined by the pyramidal shape, a large signal was produced. The pyramid is clearly instrumental in generating the signal. This finding provides the second experimental proof for the present theory of electric polarities. It also demonstrates that potentially, we may be able to tap into the electromagnetic field of our planet and draw electric energy. The practical implications of this finding are enormous.

I claim:

1. A method producing directional currents in the space lattice utilizing:
(a) separated electric charges; and
(b) the interaction of electrostatic and magnetic fields.

2. The method of claim 1 wherein said electric charges are separated in an oriented fashion.

3. The method of claim 2 wherein said orientation is a parallel orientation.

4. The method of claim 3 wherein said orientation is obtained in a capacitor.

5. The method of claim 4 wherein said capacitor is used for the propulsion of a vehicle.

6. The method of claim 5 wherein said capacitor is providing lift and lateral movement control for said vehicle.

7. The method of claim 1 wherein interaction of electrostatic and magnetic fields is set up in a pyramid.

8. The method of claim 1 wherein said interaction is producing a vortex in the space lattice.

9. The method of claim 8 wherein said vortex can be tapped to produce electric power.

10. The method of claim 9 wherein said electric power is obtained by wrapping a coil around the pyramid.
